(19) United States
(12) Patent Application Publication
(10) Pub. No.: US 2002/0093157 A1
(43) Pub. Date: Jul. 18, 2002

(54) Juvenile stroller with cooler

(76) Inventors: Dennis M. Turner, Mooresville, IN (US); Andrew Mendenhall, Indianapolis, IN (US); Paul T. Zink, Anderson, IN (US)

Correspondence Address: BARNES & THORNBURG, 11 SOUTH MERIDIAN, INDIANAPOLIS, IN, 46204

(21) Appl. No.: 10/044,362

(22) Filed: Jan. 11, 2002

Related U.S. Application Data
(60) Provisional application No. 60/261,605, filed on Jan. 12, 2001.

(51) Int. Cl. B62B 1/00

(52) U.S. Cl. 280/47.25; 280/47.26

(57) ABSTRACT

A stroller includes a frame, a seat supported by the frame, and a container selectively coupled to the frame. In one embodiment the container is a thermally insulated container. In another embodiment the container provides an insulated storage region and is slidable into an opening in a front portion of the stroller frame. In yet another embodiment the frame includes left and right frame members spaced apart to define a space therebetween, and the container includes a lid positioned below and forward of the seat when the container is attached to the stroller and in the space.

This application claims priority under 35 U.S.C. 119(e) to U.S. Provisional Application Serial No. 60/261,605, filed Jan. 12, 2001, which is expressly incorporated by reference herein.

### BACKGROUND AND SUMMARY

The present disclosure relates to juvenile strollers, and particularly to stroller accessories. More particularly, the present disclosure relates to storage units adapted to be carried onboard a juvenile stroller.

Juvenile strollers are being adapted to carry various child-care items in handy onboard locations in addition to carrying infants or other young children. Caregivers appreciate the convenience of being able to store child-care items or other items needed by caregivers or siblings onboard the stroller so that those items will be available to the caregiver when the stroller is being used to transport a child away from home or vehicle.

According to one aspect of the disclosure, a stroller comprises a frame, a seat supported by the frame, wheels provided on the frame for facilitating movement of the stroller, and a thermally insulated container configured to be selectively removably coupled to the frame.

According to another aspect of the disclosure, the juvenile stroller frame includes a front portion defining a front opening. The thermally insulated container is movable between a first position attached to the frame and a second position detached from the frame. The container is slidable into the front opening to the first position and out of the front opening to the second position.

According to a further aspect of the disclosure, the thermally insulated container includes a body and a lid movably coupled to the body. The container is configured to include a thermally insulated storage region accessible when the lid is in an open position and at least partially covered when the lid is in a closed position. The container is movable between an orientation attached to the stroller and an orientation detached from the stroller. The frame includes spaced apart left and right front frame members defining a space therebetween. The container is situated in the space when the container is in the attached orientation so that at least a portion of the lid is positioned forward of the seat and below the seat.

Additional features of the disclosure will become apparent to those skilled in the art upon consideration of the following detailed description of preferred embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a juvenile stroller in accordance with the disclosure showing a seat frame, a storage basket positioned to lie below a seat coupled to the seat frame, and a thermally insulated container configured to store items in a cooled environment, the container being situated in a compartment in the basket;

FIG. 2 is a perspective view of the thermally insulated container of FIG. 1 showing a lid partially opened to expose a storage region in the container;

FIG. 3 is a perspective view of the stroller of FIG. 1, with portions broken away, showing the compartment in an empty state, with the thermally insulated container removed therefrom;

FIG. 4 is a perspective view of a juvenile stroller similar to the stroller shown in FIG. 1 showing another style of thermally insulated container coupled to another style of basket support frame and another style of basket coupled to the basket support frame;

FIG. 5 is a perspective view of the thermally insulated container of FIG. 4 showing one of a pair of lids partially opened to expose a storage region in the container and a handle coupled to the container between the lids;

FIG. 6 is a side view, with portions broken away, of the stroller of FIG. 4, showing the thermally insulated container removed to expose the front compartment;

FIG. 7 is a perspective view of another juvenile stroller in accordance with the disclosure showing another style of thermally insulated container coupled to another style of basket support frame and another style of basket coupled to the basket support frame, with the container, in solid, situated between the storage basket and a footrest coupled to the stroller and, in phantom, removed from the stroller; and

FIG. 8 a perspective view of the thermally insulated container of FIG. 7 showing a pair of retainers coupled to the container for securing the container to the stroller, the handle in a carrying position, and the lid in a closed position.

### DETAILED DESCRIPTION OF THE DRAWINGS

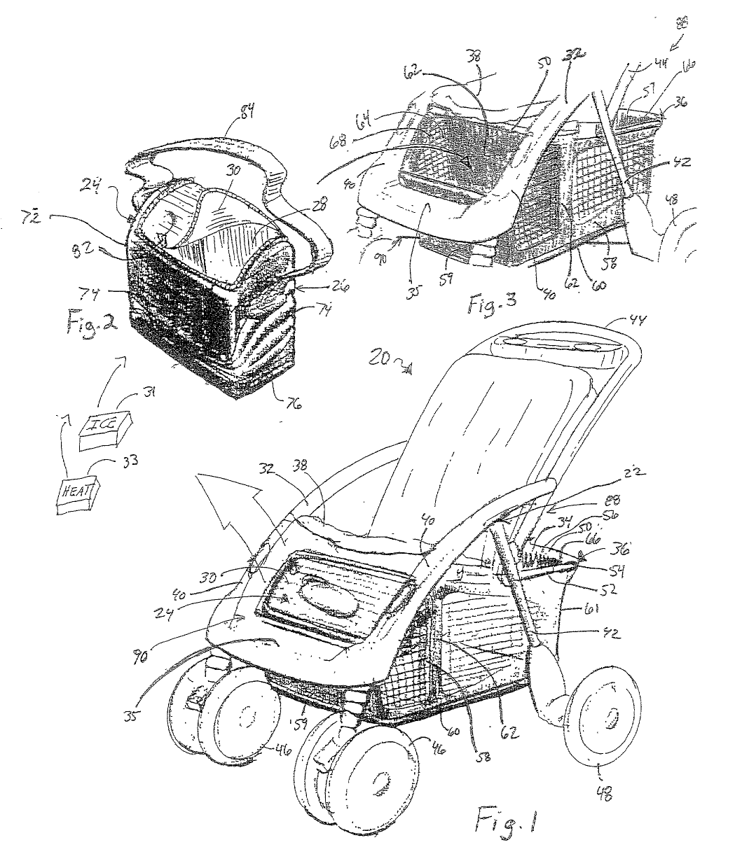

A juvenile stroller 20 includes a stroller frame 22 and a thermally insulated container 24 configured to store items as shown, for example, in FIG. 1. The thermally insulated container 24 is coupled to the stroller frame 22 as shown, for example, in FIG. 1 to move therewith as the stroller 20 is pushed.

Thermally insulated container 24 includes a container body 26 formed to include an interior storage region 28 therein and a container lid 30. Container lid 30 is coupled to container body 26 for movement between a closed position (shown in FIG. 1) closing interior storage region 28 and an opened position permitting access to interior storage region 28 (shown in FIG. 2). Container body 26 and lid 30 cooperate to provide a thermally insulated case in which child-care or other items to be maintained in a temperature controlled environment can be placed. This thermally insulated case is adapted to receive an ice pack 31, heat pack 33, or any other suitable heat source or sink to provide some control over the temperature in interior storage region 28. Container 24 functions as a thermally insulated storage region to provide some control of the temperature of articles stored therein relative to an ambient temperature outside the storage region for a period of time so that cold articles stored in the thermally insulated storage region will be insulated against heat gain and warm articles stored in the thermally insulated storage region will be insulated against heat loss.

As shown in FIG. 1, stroller frame 22 includes a seat frame 32, a basket support frame 34 coupled to seat frame 32, and a storage basket 36 coupled to basket support frame 34. A seat 38 is coupled to seat frame 32 in any suitable manner. It is within the scope of this disclosure to employ a wide variety of seats and seat frames. In the illustrated embodiment, seat frame 32 includes a pair of front legs 40, a pair of rear legs 42, and a push handle 44. A set of front wheels 46 is coupled to each front leg 40 as shown, for example, in FIGS. 1, 4, and 7, and a rear wheel 48 is coupled to each of rear legs 42 as shown, for example, in FIGS. 1, 4, and 7.

As shown in FIG. 1, basket support frame 34 has an upper rim 50 illustratively made of a tubular member that is bent to form, in series, left side section 52, left rear corner portion 54, straight rear section 56, a right rear corner portion (not shown), a right side section (not shown), a front right comer portion (not shown), a straight front section (not shown), and a front left comer portion (not shown). Storage basket 36 can be coupled to basket support frame 34 in any suitable manner. It is within the scope of this disclosure to form basket support frame 34 and storage basket 36 as a single unit if desired. Basket support frame 34 and storage basket 36 cooperate to form a container, which container can be mounted in any suitable location on stroller frame 22. In the illustrated embodiment, basket support frame 34 is coupled to seat frame 32 so that a front portion of storage basket 36 lies generally under seat 38.

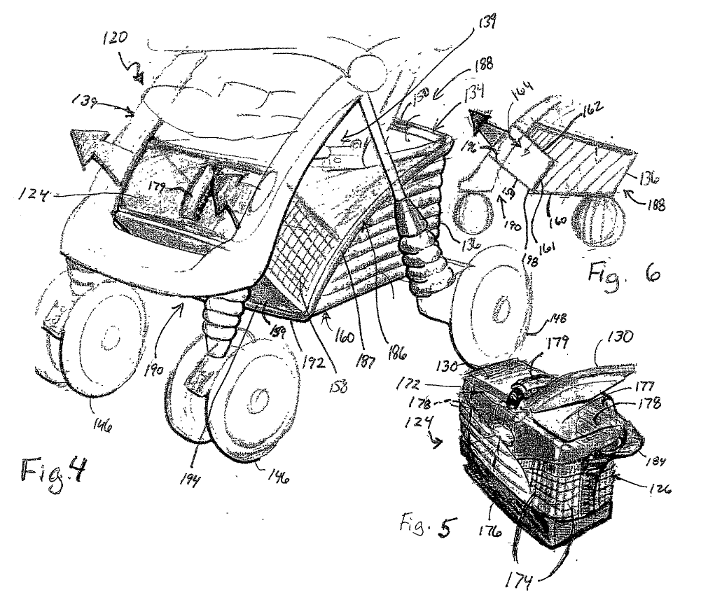

As shown in FIGS. 1 and 3, basket support frame 34 is formed to include a basket opening 57. Side walls 58, front wall 59, and rear wall 61 each extend downwardly from rim 50 and join a bottom 60, to support articles that a user places in storage basket 36. A dividing wall 62 extends upwardly from bottom 60 and cooperates with side walls 58 and bottom 60 to form two compartments, a front compartment 64 adjacent a front 90 of stroller 20 and a rear compartment 66 adjacent a rear 88 of stroller 20. Front compartment 64 has a front opening 68 between seat 24 and a footrest 35 coupled to stroller frame 22. Front opening 68 is illustratively defined in part by rim 50, however opening 68 may be defined in whole or in part by front legs 40, seat frame 32, seat 38, footrest 35, or any combination thereof. Opening 68 and front compartment 64 are sized to receive container 24 and retain it toward front 90 of stroller 20 in a convenient, out-of-the-way location generally below seat 38.

As illustrated in FIGS. 1 and 3, front compartment 64 is generally rectangular because of the relative orientations and shapes of side walls 58, front wall 59, dividing wall 62, and bottom 60. Front compartment 64 is further oriented so that walls 58, 59, and 62 are generally perpendicular to a surface upon which the stroller 20 rests to facilitate removal and replacement of container 24 by lifting and lowering it to and from its illustrated orientation in the stroller 20.

Container 24, as shown in FIGS. 1 and 2, includes an upper end 72, bottom 76, and side walls 74 coupled to and extending between upper end 72 and bottom 76 to form storage region 28. Lid 30 is coupled to upper end 72 and is illustratively attached to container 24 with a zipper 82, snaps, ties, or other suitable fasteners. Lid 30 can be hinged to upper end 72 or otherwise coupled to container 24 to permit storage region 28 to be opened and closed at the option of the user. It is within the scope of this disclosure to provide lid 30 and container 24 as a single component, for example, a molded resin component, with a flexible hinge permitting the lid 30 to be moved between its opened and closed positions.

A carrying strap 84 is provided to facilitate transport of container 24 by a user once container 24 is separated from stroller 20. Carrying strap 84 can be coupled to container 24 in any suitable manner, for example, by sewing the ends of the strap 84 to opposite side walls of the container body 26. Another example showing a strap 84 removably coupled to container body 26 is disclosed in U.S. patent application Ser. No. 09/938,951 of Andrew Mendenhall, entitled, “JUVENILE STROLLER WITH COOLER,” filed Aug. 24, 2001, the disclosure of which is hereby incorporated by reference herein.

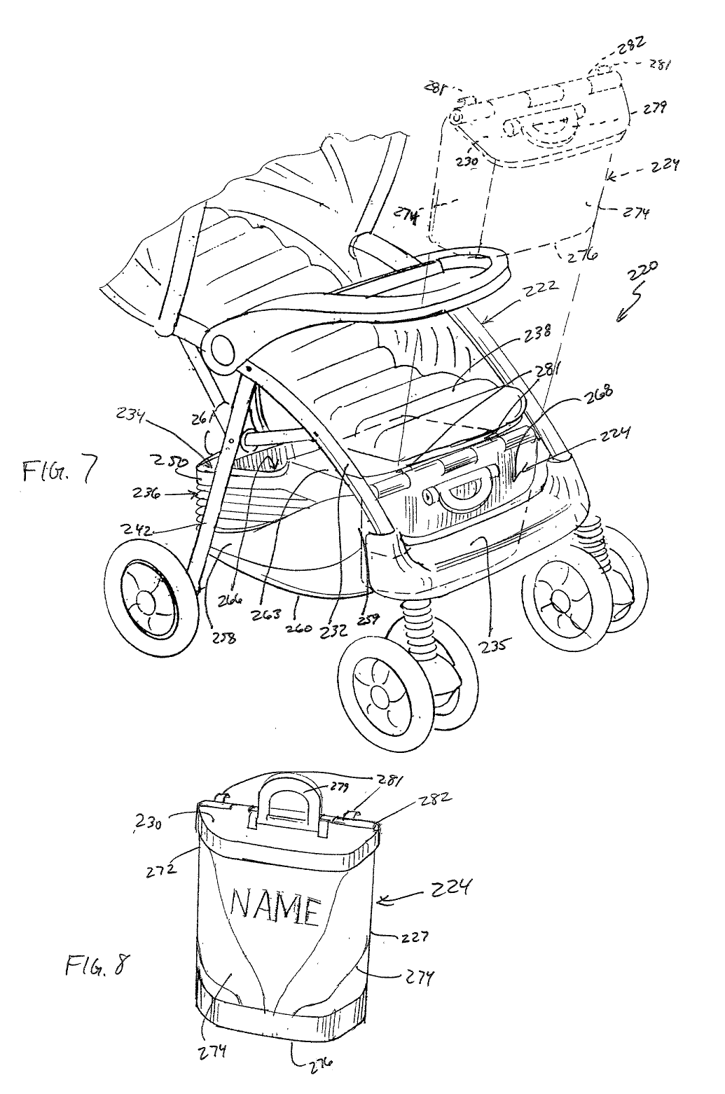

A second embodiment of a stroller having a modified container 124 and storage basket 136 is shown in FIGS. 4-7. As shown in FIG. 4, storage basket support frame 134 includes a central frame portion 186 including side frame members 187. Side frame members 187 extend from upper rim 150 at a rear 188 of stroller 120 to a front 190 of stroller 120, terminating at an intersection 192 of bottom 160 and front wall 159. Central frame portion 186 also includes lower frame member 194 extending between side frame members 187 of each side 139 of stroller 120.

As illustrated in FIGS. 4 and 5, front wall 159 is coupled at a first end 196 thereof to front 190 of stroller 120. Front wall extends toward bottom 160 at an angle of about 45 degrees to the surface upon which stroller 120 rests. A second end 198 of front wall 159 is coupled to bottom 160. A floor 161 extends from intersection 192 toward rear 188 of stroller 120 and upper rim 150. Compartment 164 is generally rectangular because of the relative orientations and shapes of side walls 158, front wall 159, dividing wall 162, and floor 161. Compartment 164 is further oriented so that front wall 159 and floor 161 form an angle of about 45 degrees. Container 124 can thus be removed and replaced by sliding container 124 out and in, respectively, of compartment 164 at about this angle.

As shown in FIG. 5, container 124 includes an upper portion 172 having a pair of lids 130 hinged to upper portion 172. Side walls 174 extend downwardly from upper portion 172 to bottom 176. A dividing wall 177 extends between side walls 174 from bottom 176 to upper end 172 to form two inner compartments 178. Container 124 is configured such that each lid 130 permits access to one of compartments 178. Compartments 178 of container 124 may also be accessed through respective lids 130 when container 124 is in front compartment 164 of stroller 120. Lids 130 can be hinged to upper portion 172 or otherwise coupled, for example, by zippers, snaps, or the like, to container 124 to permit a user to open and close either or both of inner compartments 178 at the option of the user.

Illustratively, a handle 179 is coupled to upper portion 172 of container 124 at a central location thereof so that a user can slide container 124 out of compartment 164 and transport container 124 by handle 179 independently of stroller 120. Handle 179 is oriented between lids 130, so that lids 130 can be opened and closed without interference with handle 179.

Another embodiment of a stroller 220 having a modified container 224 and storage basket 236 is shown in FIG. 7. As shown in FIG. 7, storage basket support frame 234 includes a rigid upper rim 250 illustratively coupled to rear legs 242 and to seat frame 232. Side walls 258, front wall 259, and rear wall 261 extend downwardly from rim 250 to bottom 260. Rear compartment 266 is illustratively open, as shown in FIG. 7. A front portion 263 of basket 236 is illustratively closed, and provides additional support to seat 238.

Front portion 263 of basket 236 is coupled to frame 222 so that front portion 263 is spaced apart from a footrest 235, providing a front opening 268 sized to receive container 224 for movement with stroller 220. As shown in FIGS. 7 (in phantom) and 8, container 224 includes an upper end 272, bottom 276, and side walls 274 coupled to and extending between upper end 272 and bottom 276 to form a storage region (not shown). Lid 230 is coupled to upper end 272 and is illustratively coupled to container 224 by a hinge 282, zipper, snaps, or similar structure, so that lid 230 can be moved between an opened position providing access to the storage region and a closed position as shown in FIG. 8. It is within the scope of this disclosure to form lid 230 and container 224 as a single component, wherein lid 230 is flexible and can be moved between the opened and closed positions. Container 224 includes a handle 279 pivotally coupled to lid 230. Illustratively, handle 279 is mounted generally centrally on lid 230.

Container 224 includes fasteners 281 to secure container 224 temporarily to stroller 220. Illustrative fasteners 281 are hooks that engage upper rim 250 of storage basket support frame 234 at the front 263 of basket 236 to help retain container 224 in the position shown in solid lines in FIG. 7. It is within the scope of this disclosure to include a shelf at the front 263 of basket 236 to support container 224 in the position shown in solid lines in FIG. 7. Further types of fasteners 281 are also possible, including but not limited to hook and loop fasteners, clips, ties, opposing engagement edges, and other suitable fasteners.

The thermally insulated container illustrated in FIGS. 1-3 is configured to be dropped into place into a container receiver formed in a front portion of the stroller frame and the configuration of the container support structure is geometrically simple. The thermally insulated container illustrated in FIGS. 4-6 has a rectangular, non-truncated shape and is configured to slide easily down an inclined plane into a container receiver formed in a front portion of the stroller frame. The thermally insulated container illustrated in FIGS. 7 and 8 has a carrying handle on a sloped lid.

Although the disclosure has been described in detail with reference to certain preferred embodiments, variations and modifications exist within the scope and spirit of the disclosure as described and defined in the following claims.

1. A stroller comprising
a frame,
a seat supported by the frame,
wheels provided on the frame for facilitating movement of the stroller, and
a thermally insulated container configured to be selectively removably coupled to the frame.

2. The stroller of claim 1, further comprising a compartment for receiving the container when the container is coupled to the frame.

3. The stroller of claim 2, wherein the compartment includes a front wall generally perpendicular to a surface supporting the stroller, and the container moves along the front wall between an orientation coupled to the frame and an orientation removed from the frame.

4. The stroller of claim 2, wherein the compartment includes a front wall forming an acute angle with a surface supporting the stroller, and the container moves along the front wall between an orientation coupled to the frame and an orientation removed from the frame.

5. The stroller of claim 1, wherein the container includes a fastener to couple the container to the stroller.

6. The stroller of claim 2, wherein the compartment includes a wall dividing the compartment into a front portion more readily accessible from a front of the stroller and a rear portion more readily accessible from a rear of the stroller, and the container is situated in the front portion when the container is coupled to the frame.

7. The stroller of claim 1, wherein the stroller has a front, a rear, and opposite sides extending between the front and rear, and the container is more readily accessible from the front of the stroller.

8. The stroller of claim 1, further comprising a footrest and a compartment coupled to the frame, the compartment having a rear portion more readily accessible from a rear of the stroller and a front portion more readily accessible from a front of the stroller, the front portion being spaced apart from the footrest to define a space between the front portion and the footrest to receive the container.

9. The stroller of claim 1, wherein the container includes a lid and a hinge for movably coupling the lid to the container, the lid being movable between a position closing the container and a position permitting access to the container.

10. A juvenile stroller comprising
a frame, a plurality of wheels coupled to the frame, and a seat coupled to the frame, the frame including a front portion defining an opening, and
a container selectively removably coupled to the frame, the container adapted to provide an insulated storage region, the container being movable between a first position attached to the frame and a second position detached from the frame, the container being slidable into the opening to the first position and out of the opening to the second position.

11. The stroller of claim 10, further comprising a basket coupled to the frame, the basket positioned at least partially between the seat and a surface supporting the stroller.

12. The stroller of claim 11, wherein the basket is formed to include a compartment in communication with the opening, the container being situated in the compartment when the container is in the first position.

13. The stroller of claim 12, wherein the basket includes a front wall, a rear wall, opposite side walls extending between the front wall and the rear wall, a bottom coupled to the front, rear and side walls and cooperating to form the compartment, and a dividing wall cooperating with at least two of the side walls, the front wall, and the rear wall to provide a front compartment and a rear compartment, the container being situated in the front compartment when the container is in the first position.

14. The stroller of claim 13, wherein the front compartment includes at least portions of the dividing wall, the front wall, and the side walls.

15. The stroller of claim 13, wherein the container includes a bottom wall, the basket further includes a floor extending at an angle of about forty five degrees to the bottom, and the floor engages the bottom wall when the container is in the first position.

16. The stroller of claim 11, wherein the basket includes a front portion and a rear portion, and the container is at least partially supported by the front portion when the container is in the first position.

17. A juvenile stroller comprising
a stroller frame,
a seat coupled to the stroller frame, and
a container having a body and a lid movably coupled to the body, the container configured to include a thermally insulated storage region accessible when the lid is in an open position and at least partially covered when the lid is in a closed position, the container further being movable between an orientation attached to the stroller and an orientation detached from the stroller, the frame including spaced apart left and right front frame members defining a space therebetween, the container being situated in the space when the container is in the attached orientation so that at least a portion of the lid is positioned forward of the seat and below the seat.

18. The juvenile stroller of claim 17, wherein the container further comprises one of a heat source and a heat sink.

19. The juvenile stroller of claim 17, further including a second lid movably coupled to the body, the second lid also having an open position and a closed position, at least one of the first-mentioned and second lids being movable between the opened and closed positions when the container is in the attached orientation.

20. The juvenile stroller of claim 17, further comprising a carrying handle coupled to the container.
